(19) United States
(12) Patent Application Publication
(10) Pub. No.: US 2013/0002521 A1
(43) Pub. Date: Jan. 3, 2013

(54) SCREEN RELAY DEVICE, SCREEN RELAY SYSTEM, AND COMPUTER -READABLE STORAGE MEDIUM

(75) Inventors: Mika Minematsu, Kawasaki-shi (JP); Masataka Goto, Yokohama-shi (JP); Takuya Kawamura, Kawasaki-shi (JP); Shigeo Matsuzawa, Tokyo (JP)

(73) Assignee: KABUSHIKI KAISHA TOSHIBA, Tokyo (JP)

(21) Appl. No.: 13/530,506

(22) Filed: Jun. 22, 2012

Related U.S. Application Data
(63) Continuation of application No. PCT/JP2009/071597, filed on Dec. 25, 2009.

(51) Int. Cl. G09G 5/00

(52) U.S. Cl. 345/1.1

(57) ABSTRACT

According to one embodiment, a screen relay device includes a communication unit that receives first image information from relay source devices, and transmits second image information to a relay destination device, a determining unit that determines a storage area of the first image information in a first storage unit, a rendering unit that renders the first image information in the determined storage area, and a screen transfer unit. The screen transfer unit compares the first image information corresponding to an updated region where the image information stored in the first storage unit has been updated by the rendering of the rendering unit and the second image information corresponding to the updated region to extract a difference region, and writes the first image information of the difference region to a second storage unit as the second image information.

### CROSS REFERENCE TO RELATED APPLICATIONS

This application is a continuation application of International Application No. PCT/JP2009/071597, filed on Dec. 25, 2009, the entire contents of which are incorporated herein by reference.

### FIELD

Embodiments described herein relate generally to a screen relay device, a screen relay system, and a computer-readable storage medium.

### BACKGROUND

A screen transfer system in which a display terminal having an input/output interface is disposed on the user side, and a server device located at a remote site executes complex computation processes is known. The server device renders screen information displayed on the display terminal in accordance with operation information from the display terminal and transfers the screen information corresponding to an updated region of a display screen to the display terminal. The server device transfers the screen information to one or a plurality of display terminals. In the server device, a rendering process, a difference extracting process, a compression process, and a transfer process are executed in a single thread.

However, in the screen relay system which handles a large quantity of image information, in which screen information is received from a plurality of server devices and transferred to a plurality of display terminals, when the screen transfer method of the related art is used, there is a problem in that only one screen can be transferred to a plurality of display terminals. Moreover, since the respective processes are executed in a single thread, there is a problem in that screen transfer performance is low.

### BRIEF DESCRIPTION OF THE DRAWINGS

FIG. 1 is a schematic configuration diagram of a screen relay system according to a first embodiment of the invention;

FIG. 2 is a diagram illustrating an example of screen relaying;

FIG. 3 is a schematic configuration diagram of a screen relay device;

FIGS. 4A to 4D are diagrams illustrating examples of an updated region;

FIGS. 5A to 5C are diagrams illustrating examples of boundary information;

FIG. 6 is a diagram illustrating an example of a method of calculating the number of threads processed in parallel;

FIG. 7 is a diagram illustrating an example of a method of calculating the number of threads processed in parallel;

FIG. 8 is a diagram illustrating an example of a method of calculating the number of threads processed in parallel;

FIG. 9 is a diagram illustrating an example of a method of calculating the number of threads processed in parallel;

FIG. 10 is a diagram illustrating an example of parallel processing in a screen transfer unit;

FIG. 11 is a flowchart for describing an image rendering process;

FIG. 12 is a flowchart for describing an image transfer process;

FIG. 13 is a schematic configuration diagram of a screen relay system according to a second embodiment of the invention;

FIG. 14 is a schematic configuration diagram of a screen relay device according to the second embodiment;

FIG. 15 is a schematic configuration diagram of a screen relay system according to a third embodiment of the invention; and

FIG. 16 is a schematic configuration diagram of a screen relay device according to the third embodiment.

### DETAILED DESCRIPTION

According to one embodiment, a screen relay device comprises a communication unit that transmits an image information acquisition request to a plurality of relay source devices, receives first image information corresponding to the image information acquisition request from the relay source devices, and transmits second image information to a relay destination device, a first storage unit that stores the first image information, a second storage unit that stores the second image information, a determining unit that determines a storage area of the first image information in the first storage unit, a rendering unit that renders the first image information in the determined storage area, a third storage unit that stores an updated region where the image information stored in the first storage unit has been updated by the rendering of the rendering unit, and a screen transfer unit. The screen transfer unit reads the first image information corresponding to the updated region from the first storage unit, reads the second image information corresponding to the updated region from the second storage unit, compares the read first image information and the read second image information to extract a difference region, writes the first image information of the difference region to the second storage unit as the second image information, and outputs the second image information to the communication unit.

Hereinafter, embodiments of the present invention will be described with reference to the drawings.

### First Embodiment

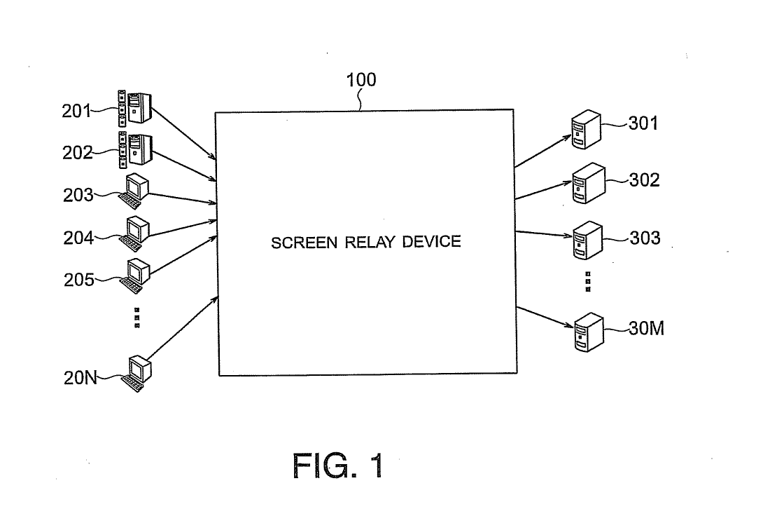

FIG. 1 illustrates a schematic configuration of a screen relay system according to a first embodiment of the invention.

The screen relay system includes a screen relay device 100, N relay source devices 201 to 20N, and M relay destination devices 301 to 30M. Here, N and M are integers of 1 or more.

The relay source devices 201 to 20N are server devices that create image information. The image information is information on an image displayed on the screen of each of the relay destination devices 301 to 30M which are display terminals disposed on the user side.

The relay source devices 201 to 20N create and transmit the image information corresponding to one screen displayed by the relay destination devices 301 to 30M when starting a screen transfer process. After that, the relay source devices 201 to 20N transmit only the image information of a region where an updating occurs within the screen of the relay destination device. The updating will be described later.

The relay source devices 201 to 20N may transmit the image information only when an image information acquisition request message is received and may transmit the image information every predetermined period.

The screen relay device 100 combines N image information items transmitted from the N relay source devices 201 to 20N. The screen relay device 100 selects image information corresponding to a predetermined region or arbitrary M regions of a combined image. Then, the screen relay device 100 transmits the image information corresponding to first, second, . . . , and M-th regions to the relay destination devices 301, 302, . . . , and 30M, respectively. The screen relay device may also generate the image information to be transmitted to the relay destination devices 301 to 30M within the own device.

Moreover, the screen relay device 100 may receive operation information (described later) transmitted from the relay destination devices 301 to 30M and transmit the same to the relay source devices 201 to 20N. Moreover, the screen relay device 100 transmits the image information acquisition request message to the relay source devices 201 to 20N. The image information acquisition request message may be generated by the screen relay device 100 and may be received from the relay destination devices 301 to 30M.

The relay destination devices 301 to 30M include a display unit (display screen) and can display the image information received from the screen relay device 100. The display unit is a liquid crystal display device, for example.

Moreover, the relay destination devices 301 to 30M include an input device such as a keyboard and a mouse. The relay destination devices 301 to 30M receive the operation information from the user via the input device. The operation information is a movement of a cursor, an input character, a position where an operation occurs, and the like, for example. A change in the screen occurring due to the operation information is the above-described updating. The relay destination devices 301 to 30M transmit the operation information to the screen relay device 100.

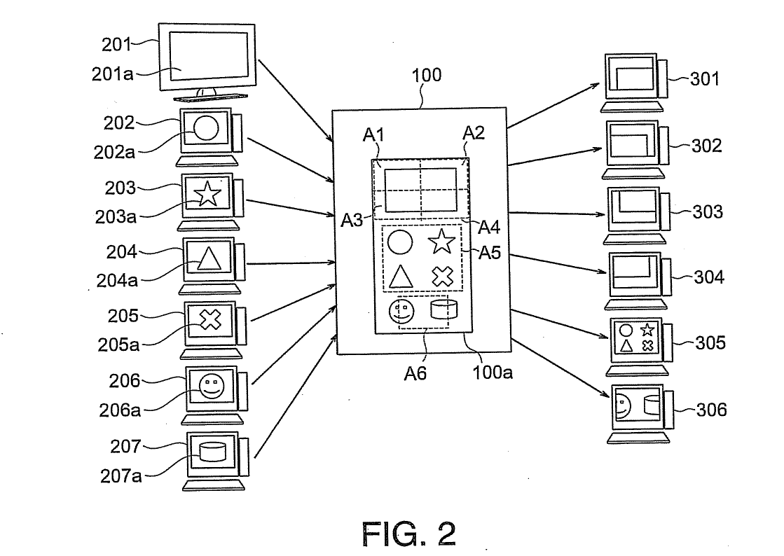

FIG. 2 illustrates an example of screen relaying by the screen relay system. The relay source devices 201 to 207 create the image information representing images 201a to 207a, respectively, and transmit the same to the screen relay device 100.

Upon receiving the image information representing the images 201a to 207a from the relay source devices 201 to 207, the screen relay device 100 renders a combined image 100a of these images. Moreover, the screen relay device 100 transmits the image information corresponding to an arbitrary or predetermined region of the combined image 100a to the relay destination devices 301 to 306.

The screen relay device 100 transmits the image information corresponding to one screen of a display unit of the relay destination device when starting the screen transfer process. After that, the screen relay device 100 specifies a region (difference region) where a change occurs within the display screen and compresses and transmits the image information corresponding to the difference region.

The relay destination devices 301 to 306 display the image information transmitted from the screen relay device 100 on the screen of the display unit. For example, the relay destination devices 301 to 304 display regions A1 to A4 of the combined image 100a. That is, the relay destination devices 301 to 304 display four divided images of an image 201a created by the relay source device 201, respectively.

The relay destination device 305 displays a region A5 of the combined image 100a. That is, the relay destination device 305 displays a combined image of the images 202a to 205a created respectively by the relay source devices 202 to 205.

The relay destination device 306 displays a region A6 of the combined image 100a. That is, the relay destination device 306 displays an image bridging over the two images 206a and 207a created respectively by the relay source devices 206 and 207.

As above, the screen relay device 100 may divide an image created by one relay source device into multiple parts and transmit the divided images to a plurality of relay destination devices, may combine the images created by a plurality of relay source devices and transmit the combined image to one relay destination device, and may transmit an image bridging over the images created by a plurality of relay source devices to one relay destination device.

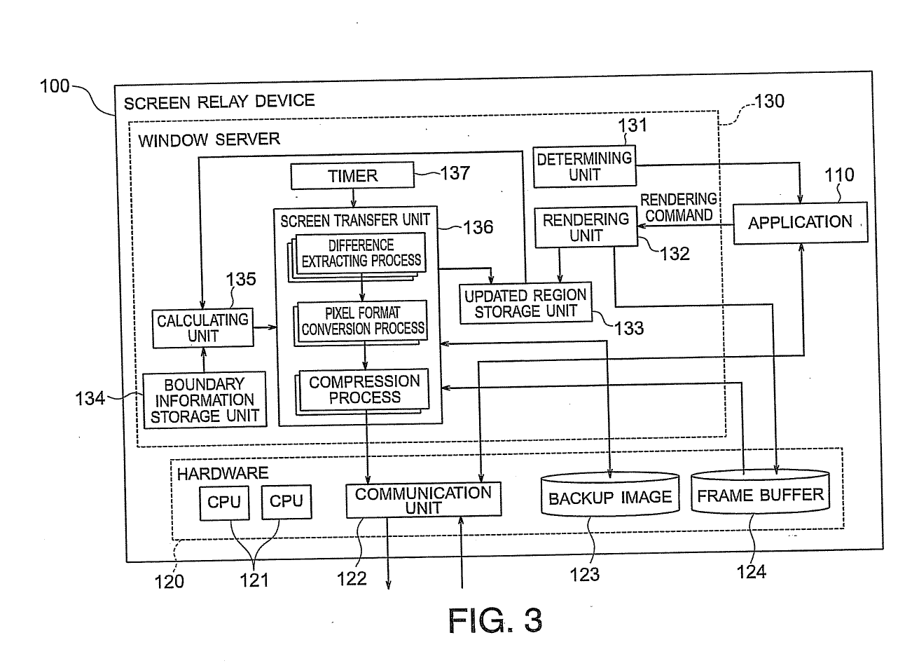

A schematic configuration of such a screen relay device 100 is illustrated in FIG. 3. The screen relay device 100 includes an application 110, hardware 120, and a window server 130.

The application 110 is a program that provides various processes operating on the screen relay device 100. The application 110 receives image information from the relay source devices 201 to 20N via a communication unit 122. Moreover, the application 110 receives operation information from the relay destination devices 301 to 30M via the communication unit 122.

The application 110 determines whether the operation information is information to be transmitted (transferred) to the relay source device or information to be processed within the screen relay device 100 based on the position where an operation has occurred, included in the operation information. When the operation information is determined to be the information to be transmitted to the relay source device, the application 110 transmits the operation information to the relay source device via the communication unit 122.

Based on the image information received from the relay source device or the operation information determined to be processed within the screen relay device 100, the application 110 detects whether a change (updating) has occurred in the screen displayed by the relay destination device. When a change (updating) occurs in the screen displayed by the relay destination device, the application 110 outputs an image rendering command to a rendering unit 132 of the window server 130. The operation of the rendering unit 132 based on the rendering command will be described later.

The hardware 120 includes a CPU 121, the communication unit 122, a backup image storage unit 123, and a frame buffer 124.

The Central Processing Unit (CPU) 121 is a control unit that executes the application 110 and the window server 130. The screen relay device 100 may be a multi-processor in which a plurality of CPUs 121 are mounted and may be a multi-core processor in which a plurality of processor cores are integrated into one package.

The screen relay device 100 may divide one processing content into a plurality of processing units (threads) and allocate the plurality of threads to the respective CPUs (processor cores) so that parallel processing is performed by the plurality of CPUs.

The communication unit 122 performs transmission of the screen information acquisition request message to the relay source device, reception of image information from the relay source device, transmission of image information to the relay destination device, and the like. Moreover, the communication unit 122 receives the operation information from the relay destination device and transmits the operation information to the relay source device.

The backup image storage unit 123 stores the image information transmitted to the relay destination device. The frame buffer 124 stores the image information of an image rendered by the rendering unit 132 based on the image information received from the relay source device or the operation information received from the relay destination device. The backup image storage unit 123 and the frame buffer 124 can be configured as various commonly used storage media such as a Random Access Memory (RAM), a Hard Disk Drive (HDD), an optical disc, or a memory card.

The window server 130 includes a determining unit 131, the rendering unit 132, an updated region storage unit 133, a boundary information storage unit 134, a calculating unit 135, a screen transfer unit 136, and a timer 137.

The determining unit 131 determines a position of the frame buffer at which the image information received from the relay source devices 201 to 20N is rendered and notifies the application 110 of the rendering position. The rendering position notified to the application 110 is included in the rendering command output by the application 110.

A method of determining the rendering position is optional. For example, the determining unit 131 allocates the rendering position from the uppermost position of the frame buffer 124 in the reception order of the image information from the relay source devices 201 to 20N.

The rendering unit 132 performs various image processes based on the rendering command received from the application 110 to create an image (combined image) and stores image information in the frame buffer 124. Moreover, the rendering unit 132 specifies an updated region where updating (change) of the image occurs in the display unit of the relay destination device using coordinate information representing an operation occurring position included in the rendering command. The rendering unit 132 records the specified updated region in the updated region storage unit 133.

Here, the coordinate information means information expressed by a coordinate system in which the top left corner of a screen is (0, 0), and the bottom right corner of the screen is (1023, 767) when the screen includes pixels of 1024×768, for example. A method of recording the updated region in the updated region storage unit 133 may be an optional method capable of identifying the updated region on the display screen of the relay destination device. For example, updated regions like “a rectangular region having a width of 10 pixels and a height of 10 pixels from a coordinate (0, 0) and a rectangular region having a width of 200 pixels and a height of 5 pixels from a coordinate (30, 30)” may be recorded as a list of rectangle information.

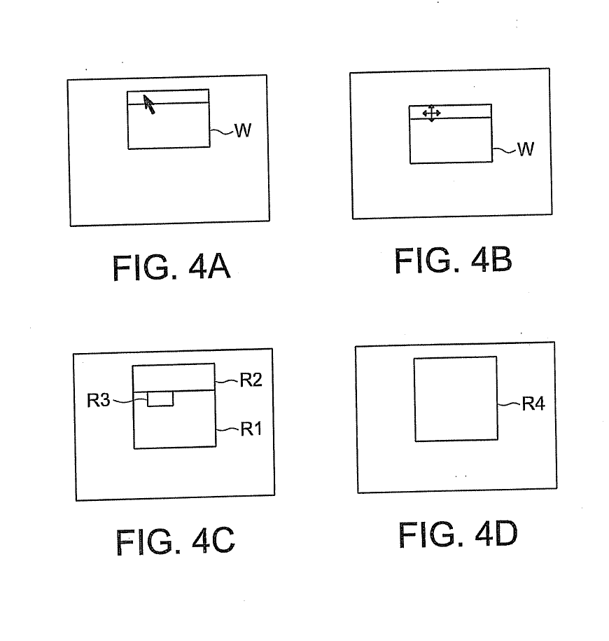

FIGS. 4A to 4D illustrate examples of the updated region. For example, a user inputs an operation of moving a window W from the position illustrated in FIG. 4A in a downward direction to the position illustrated in FIG. 4B.

By this operation, a first rendering command “copy a rectangular region having a width of 350 pixels and a height of 200 pixels from the coordinate (300, 50) to the position of the coordinate (300, 200)” for moving the window W in a downward direction, a second rendering command “render a rectangular region having a width of 350 pixels and a height of 150 pixels at the position of the coordinate (300, 50)” for reconstructing a region concealed by the window W, and a third rendering command “render a rectangular region having a width of 50 pixels and a height of 50 pixels at the position of the coordinate (350, 200)” for rendering a cursor image representing the window is being dragged are generated.

An updated region by the first rendering command is a rectangular region R1 having a width of 350 pixels and a height of 200 pixels from the coordinate (300, 200) as illustrated in FIG. 4C. Moreover, an updated region by the second rendering command is a rectangular region R2 having a width of 350 pixels and a height of 150 pixels from the coordinate (300, 50) as illustrated in FIG. 4C. Moreover, an updated region by the third rendering command is a rectangular region R3 having a width of 50 pixels and a height of 50 pixels from the coordinate (350, 200) as illustrated in FIG. 4C.

Moreover, the rectangular regions R1 to R3 are recorded in the updated region storage unit 133 as the updated regions.

Since the rectangular regions R1 to R3 are a continuous region, the three rectangular regions may be combined into one region, and a rectangular region R4 having a width of 350 pixels and a height of 350 pixels from the coordinate (300, 50) as illustrated in FIG. 4D may be recorded in the updated region storage unit 133 as the updated region.

The boundary information storage unit 134 stores boundary information of the combined image stored in the frame buffer 124. The boundary information is information representing the boundaries of a region displayed by the relay destination device, in the combined image stored in the frame buffer 124.

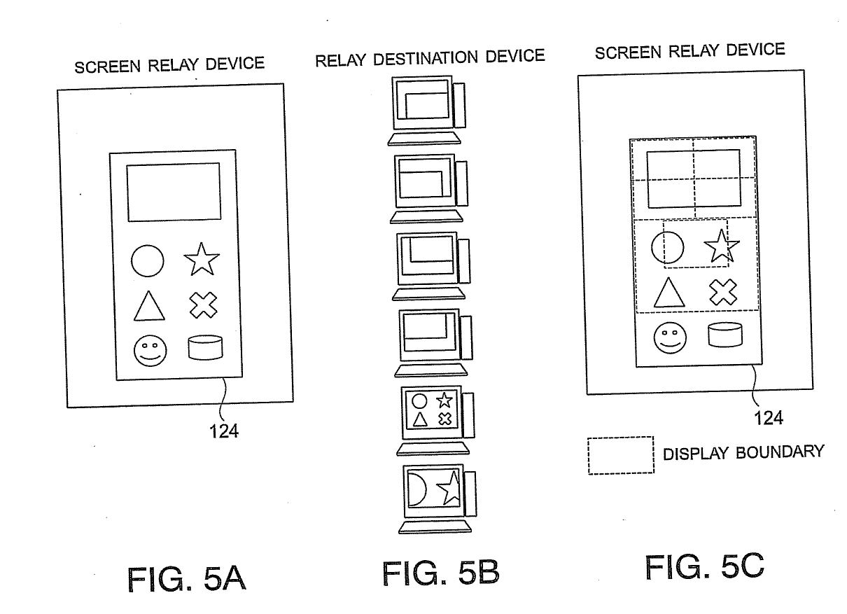

For example, when a combined image as illustrated in FIG. 5A is stored in the frame buffer 124, and an image as illustrated in FIG. 5B is displayed by the relay destination devices 301 to 306, broken lines illustrated in FIG. 5C become display boundaries. The boundary information storage unit 134 stores information representing these boundaries.

The calculating unit 135 calculates the number of threads (parallel count) processed in parallel in the screen transfer unit 136, using at least any one of information items such as the number of updated regions, the area of each updated region, the boundary information, and the number of mounted CPUs 121. The screen transfer unit 136 can execute a difference extracting process described later or the like in parallel with respect to a plurality of processing regions. A unit processing region processed in parallel is determined by dividing or grouping updated regions.

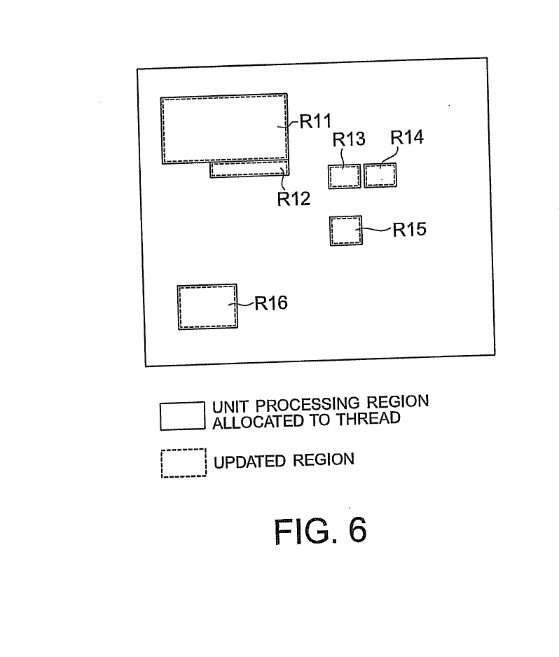

FIGS. 6 to 9 illustrate an example of a method of calculating the number of threads processed in parallel. In the example illustrated in FIGS. 6 to 8, it is assumed that six rectangular regions R11 to R16 are stored in the updated region storage unit 133 as updated regions in a combined image. In FIGS. 6 to 8, the updated regions are depicted by broken lines.

FIG. 6 illustrates an example of calculating the number of threads based on the number of updated regions. Since there are six updated regions, the number of threads is 6. That is, six threads of the screen transfer unit 136 performs processes on the image information corresponding to the updated regions (rectangular regions) R11 to R16, respectively.

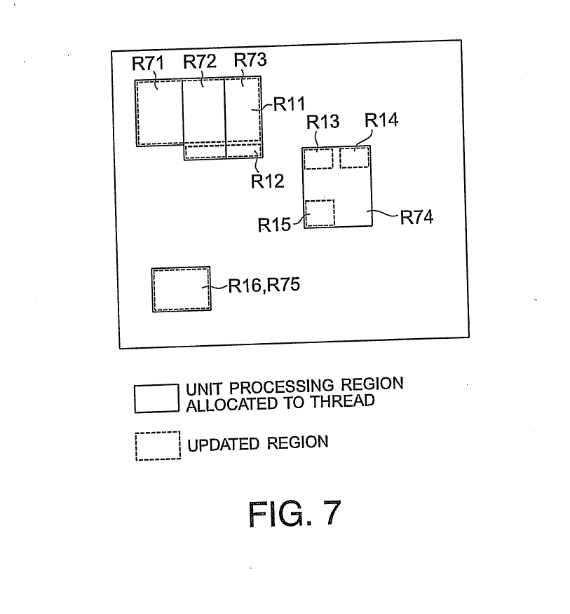

FIG. 7 illustrates an example of calculating the number of threads based on the area of each updated region. The area of the updated region is 100 (=10×10) when the updated region has a width of 10 pixels and a height of 10 pixels and is 1000 (=200×5) when the updated region has a width of 200 pixels and a height of 5 pixels.

In order to equalize the areas of the regions allocated to the respective threads, threshold values Th1 and Th2 (Th1>Th2) are provided for the region area so that an updated region having an area larger than the threshold value Th1 is divided into a plurality of regions, and a plurality of updated regions having an area smaller than the threshold value Th2 are grouped into one region.

Since the updated region R11 has a large area, the updated region is divided. Since the updated region R12 is adjacent to the updated region R11, it is ideal to combine the updated regions R11 and R12 into one region and to divide the combined region. As illustrated in FIG. 7, the updated regions R11 and R12 are combined into one region, which is then divided into three processing regions R71 to R73.

Since the updated regions (rectangular regions) R13 to R15 have a small area, the updated regions are grouped into one region as a processing region R74.

Since an area of the updated region R16 is threshold value Th1 or smaller and the threshold value Th2 or larger, the updated region becomes a processing region R75. Thus, the number of threads (the number of regions processed in parallel by the screen transfer unit 136) is 5. In this way, by taking the area of the updated region into consideration, it is possible to equalize the amount of processing by the respective threads.

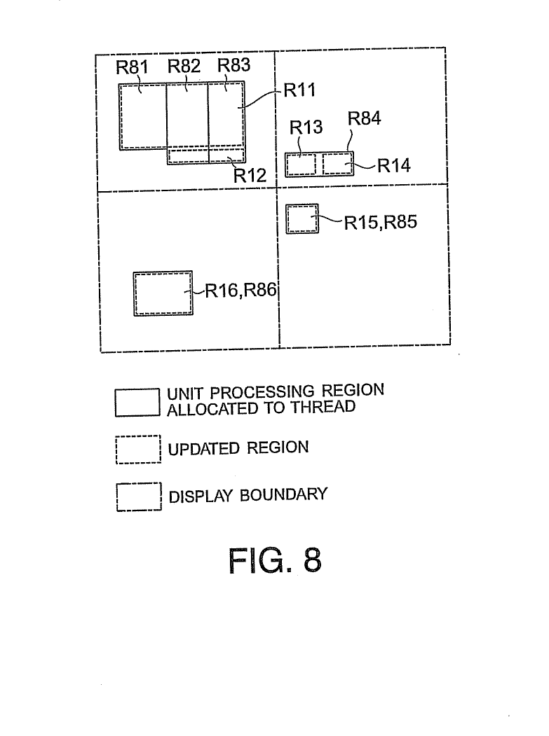

FIG. 8 illustrates an example of calculating the number of threads based on the area of the updated region and the boundary information. It is assumed that the display boundaries are obtained by dividing the combined image into four parts as indicated by a one-dot chain line. When the processing region determined based on the area of the updated region crosses the display boundaries, the processing region is divided so as not to exceed the display boundaries. Thus, in this example, a processing region R74 in FIG. 7 is divided into processing regions R84 and R85. The processing region R84 is obtained by grouping the updated regions R13 and R14, and the processing region R85 corresponds to the updated region R15.

The processing regions R81 to R83 and R86 correspond to the processing regions R71 to R73 and R75 in FIG. 7. Thus, in the example illustrated in FIG. 8, the number of threads (the number of regions processed in parallel by the screen transfer unit 136) is 6.

By taking the regions displayed by the plurality of relay destination devices 301 to 30M into consideration using the boundary information, it is possible to allocate one thread to one relay destination device.

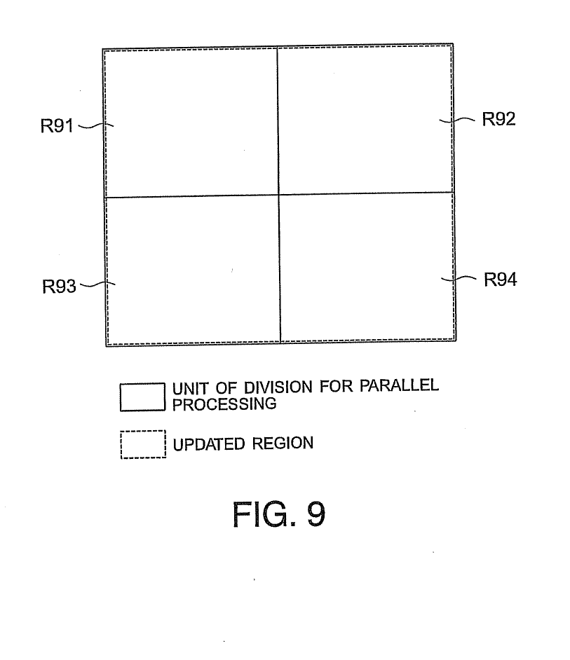

FIG. 9 illustrates an example of calculating the number of threads based on the number of mounted CPUs 121. The number of threads processed in parallel by the screen transfer unit 136 is limited by the number of mounted CPUs 121. Thus, the number of mounted CPUs 121 is calculated as the number of threads. For example, when four CPUs 121 are mounted, the number of threads is set to 4.

In FIG. 9, it is assumed that updating of the entire screen occurs, and one updated region (rectangular region) corresponding to the entire screen is stored in the updated region storage unit 133. When the number of mounted CPUs 121 is 4, as illustrated in FIG. 9, the entire screen is evenly divided into four processing regions R91 to R94.

When the number of updated regions is larger than the number of mounted CPUs 121, in order to suppress the number of threads (the number of processing regions) to be equal to or smaller than the number of mounted CPUs 121, a plurality of updated regions are grouped into one processing region.

The calculating unit 135 can use an optional combination of information items such as the number of updated regions, the area of each updated region, the boundary information, and the number of mounted CPUs 121 for calculating the number of threads. Moreover, the calculating unit 135 may calculate the number of threads for one process and may calculate the number of threads for each of the processes such as a difference extracting process, a pixel format conversion process, and a compression process described later, executed by the screen transfer unit 136.

For example, in the case of the difference extracting process, the number of threads is calculated based on the number of updated regions as illustrated in FIG. 6, and when the calculated number of threads is smaller than the number of mounted CPUs 121, an updated region having an area larger than the threshold value Th1 is divided.

Moreover, for example, in the case of the pixel format conversion process and the compression process, there is a possibility that the relay destination devices handle screen information having different formats such as a pixel format or a compression format. Thus, in order for the relay destination devices to process in different threads, the number of threads is calculated by taking the boundary information into consideration.

As above, since the calculating unit 135 calculates the number of threads processed in parallel by the screen transfer unit 136 in accordance with the number of mounted CPUs and the processing content by the screen transfer unit 136 and determines the processing region processed in parallel, the screen transfer unit 136 can execute parallel processing efficiently.

The screen transfer unit 136 reads image information corresponding to the updated regions from the frame buffer 124 by referring to the updated regions stored in the updated region storage unit 133. The image information read from the frame buffer 124 is the image information created by the rendering unit 132, in which the operation information received from the relay destination devices 301 to 30M is reflected.

Moreover, the screen transfer unit 136 reads the image information corresponding to these regions from the backup image storage unit 123. The image information read from the backup image storage unit 123 is the image information which was transmitted to the relay destination devices 301 to 30M and displayed by the relay destination devices 301 to 30M.

Moreover, the screen transfer unit 136 executes the difference extracting process in parallel for each of the processing regions determined by the calculating unit 135. The difference extracting process is a process of comparing the image information read from the frame buffer 124 with the image information read from the backup image storage unit 123 to thereby extract a difference region (region having different image information).

The screen transfer unit 136 updates the image information stored in the backup image storage unit 123 with respect to the extracted difference region. Moreover, the screen transfer unit 136 overwrites the updated region in the updated region storage unit 133 with the difference region. The screen transfer unit 136 performs a pixel format conversion process after the difference extracting process is performed. The pixel format conversion process is a process of converting the pixel format of the screen relay device 100 into the pixel format of the relay destination devices 301 to 30M. When the pixel formats of both are same, this process may not be performed. The pixel format includes a “bpp” (the number of bits per pixel), a depth (the number of colors displayable with one pixel), and a color map (which defines a correspondence between a color number and an actual color). The screen transfer unit 136 performs a compression process to compress the image information of the difference region after the pixel format conversion process is performed. The compressed image information is transmitted to the relay destination devices 301 to 30M via the communication unit 122.

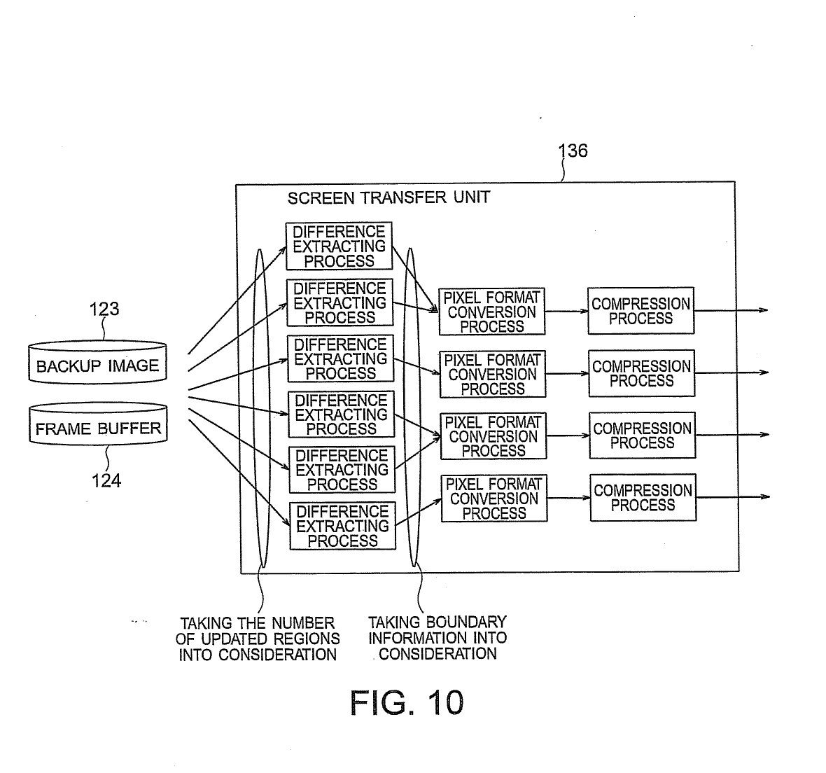

For example, as illustrated in FIG. 10, the screen transfer unit 136 performs the difference extracting process using a number of threads based on the number of updated regions and performs the pixel format conversion process and the compression process using a number of threads based on the boundary information.

The screen transfer unit 136 deletes information of the region (difference region) corresponding to the image information transmitted to the relay destination device from the updated region storage unit 133 after the compression process is performed.

The timer 137 sends an interrupt notification to the screen transfer unit 136 every predetermined time. The screen transfer unit 136 starts the above-described difference extracting process and the like based on the interrupt notification. The trigger for starting the process by the screen transfer unit 136 may not be the interrupt notification from the timer 137. For example, the screen transfer unit 136 may start the process when the number of times of rendering by the rendering unit 132 reaches a predetermined value.

As described above, the image process performed by the screen relay device 100 can be classified into two processes of an image rendering process of writing an updated image to the frame buffer 124 and an image transfer process of transferring the image information of the updated region to the relay destination device.

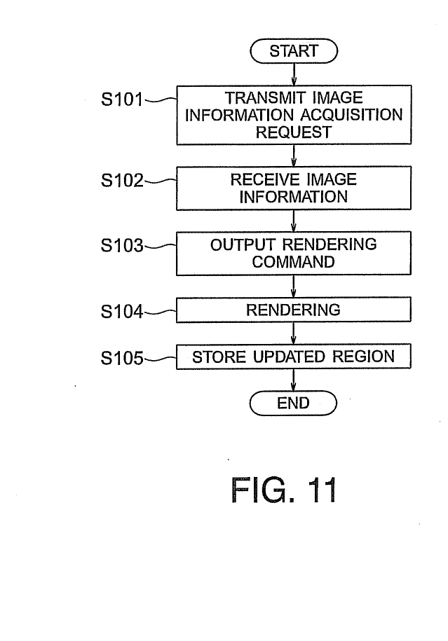

The image rendering process will be described using the flowchart illustrated in FIG. 11.

### (Step S101)

A screen information acquisition request message is transmitted from the screen relay device 100 to the relay source devices 201 to 20N.

### (Step S102)

The application 110 receives the image information from the relay source devices 201 to 20N.

### (Step S103)

The application 110 executes a process in accordance with the image information from the relay source devices 201 to 20N, and outputs a rendering command requesting rendering of a combined image to the rendering unit 132 when an updating of the image information has occurred.

The image information may be generated on the screen relay device 100. In this case, the application 110 outputs the rendering command to the rendering unit 132 based on the operation information from the relay destination devices 301 to 30M.

### (Step S104)

The rendering unit 132 performs an image process in accordance with the rendering command, renders the combined image as illustrated in FIG. 2, and stores the image information of the combined image in the frame buffer 124. The rendering unit 132 renders the image of the updated region after the combined image of the entire screen is created when the operation of the screen relay device 100 is started.

### (Step S105)

The rendering unit 132 stores the updated region (the coordinate thereof) in the updated region storage unit 133.

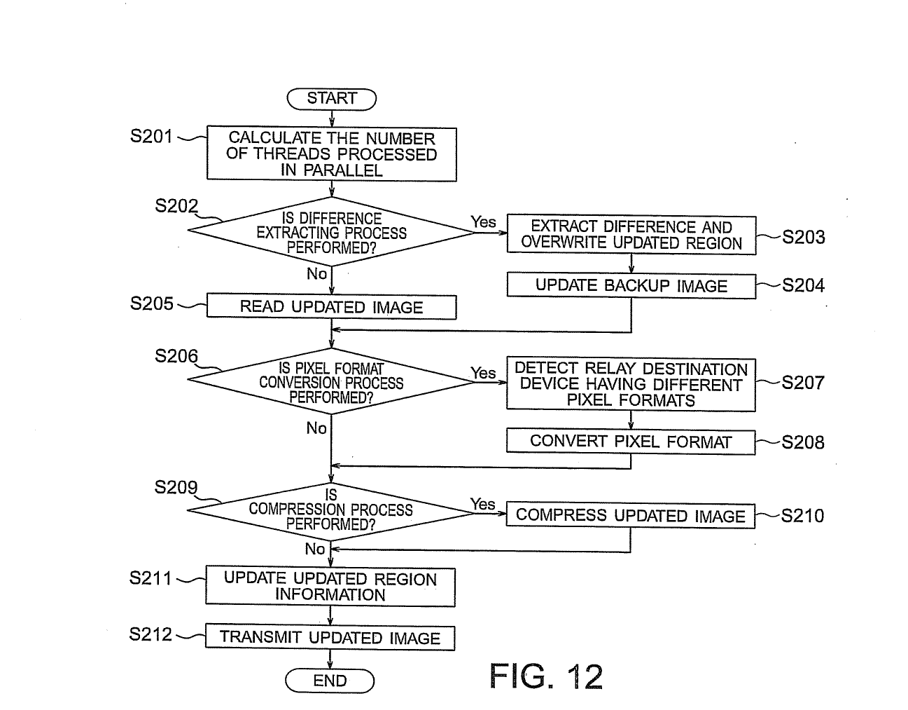

The image transfer process will be described using the flowchart illustrated in FIG. 12.

### (Step S201)

The calculating unit 135 calculates the number of threads in which the image information is processed in parallel by the screen transfer unit 136. The number of threads may be calculated for each of the difference extracting process, the pixel format conversion process, and the compression process executed by the screen transfer unit 136, the number of threads may be calculated for one process, and the number of threads may be applied to all of the processes. The subsequent process of the screen transfer unit 136 is performed in parallel in accordance with the number of threads calculated herein.

### (Step S202)

It is determined whether the difference extracting process is performed. The flow proceeds to step S203 when the difference extracting process is performed, and the flow proceeds to step S205 when the difference extracting process is not performed.

### (Step S203)

The image information (of the updated image) in the frame buffer 124 corresponding to the updated region and the image information in the backup image storage unit 123 are compared by referring to the updated region stored in the updated region storage unit 133, and the difference region is extracted. Moreover, the difference region is overwritten to the updated region in the updated region storage unit 133.

### (Step S204)

The image information of the updated image corresponding to the difference region is stored in the backup image storage unit 123.

### (Step S205)

The screen transfer unit 136 reads the image information of the updated image corresponding to the updated region from the frame buffer 124.

### (Step S206)

It is determined whether the pixel format conversion process is performed. The flow proceeds to step S207 when the pixel format conversion process is performed, and the flow proceeds to step S209 when the pixel format conversion process is not performed.

### (Step S207)

A relay destination device having a pixel format different from that of the screen relay device 100 is detected.

### (Step S208)

The pixel format of the updated image of the updated region transmitted to the relay destination device detected in step S207 is converted.

### (Step S209)

It is determined whether the compression process is performed. The flow proceeds to step S210 when the compression process is performed, and the flow proceeds to step S211 when the compression process is not performed.

### (Step S210)

The updated image of the updated region is compressed.

### (Step S211)

The updated region corresponding to the updated image transmitted to the relay destination device is deleted from the updated region storage unit 133.

### (Step S212)

The updated image is transmitted to the relay destination device via the communication unit 122. As described above, the screen relay device 100 can combine the images received from N relay source devices 201 to 20N and transmit an arbitrary region of the combined image to M relay destination devices 301 to 30M. That is, the screen relay device 100 can arbitrarily combine or divide the images created by N relay source devices, such as the divided images of the image created by one relay source device, a combined image of the images created by a plurality of relay destination devices, or an image bridging over the image created by the plurality of relay destination devices and transfer the combined image or the divided images to M relay destination devices.

Moreover, the calculating unit 135 calculates the number of threads used for the difference extracting process or the like executed by the screen transfer unit 136 using information such as the number of updated regions, the area of each updated region, the boundary information, and the number of mounted CPUs 121. Therefore, the screen relay device 100 cab transmit the image information of the screen created by the relay source device to the relay destination device efficiently.

As above, according to the present embodiment, it is possible to improve screen transfer performance of the screen relay device.

In the first embodiment, although the screen relay device 100 renders one kind of combined image and stores the rendered image in the frame buffer 124, when the combined image rendered by the screen relay device 100 is different from the combined image requested by the relay destination device, the combined image requested by the relay destination device may be stored in a separate area of the frame buffer 124.

For example, in the combined image 100a illustrated in FIG. 2, although the image 202a created by the relay source device 202 is positioned on the left side of the image 203a created by the relay source device 203, when a combined image in which the positions of the two images are switched is requested from the relay destination device, such a combined image is rendered and stored in a separate area of the frame buffer 124.

Moreover, a plurality of frame buffers 124 may be provided so as to correspond to the respective relay destination devices so that the combined images requested by the respective relay destination devices are rendered and stored in the frame buffers.

The relay destination device having received the image information from the screen relay device 100 may switch the positions of the images so that the images are displayed at desired positions.

### Second Embodiment

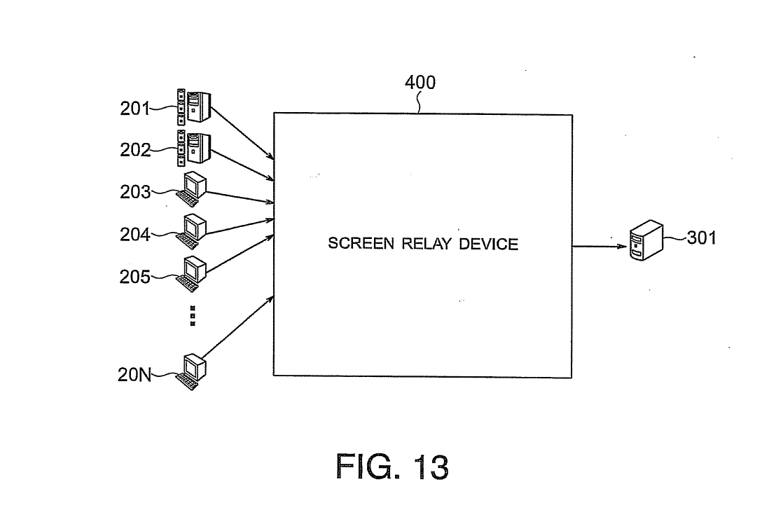

FIG. 13 illustrates a schematic configuration of a screen relay system according to a second embodiment of the invention. The screen relay system includes a screen relay device 400, N relay source devices 201 to 20N, and one relay destination device 301. Here, N is an integer of 1 or more. The screen relay device 400 arbitrarily combines or divides the images created by the relay source devices 201 to 20N and transmits the combined image or the divided images to the relay destination device 301. Moreover, when an image displayed by the relay destination device 301 is updated (when a change occurs), the screen relay device 400 transmits an updated image to the relay destination device 301.

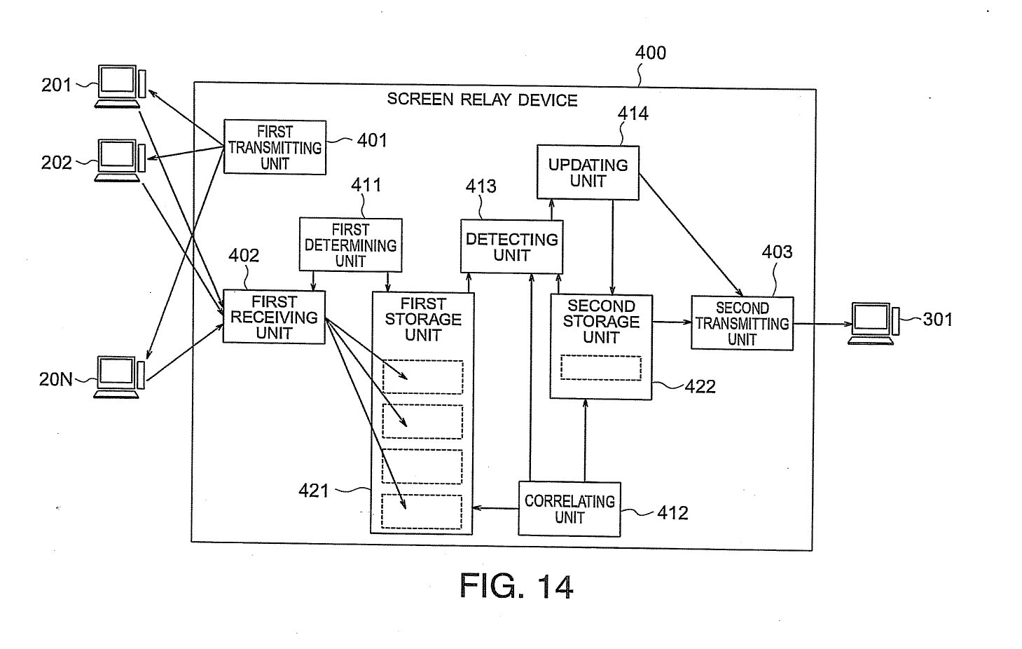

FIG. 14 illustrates a schematic configuration of the screen relay device 400. The screen relay device 400 includes a first transmitting unit 401, a first receiving unit 402, a second transmitting unit 403, a first determining unit 411, a correlating unit 412, a detecting unit 413, an updating unit 414, a first storage unit 421, and a second storage unit 422.

The first transmitting unit 401 transmits an image information acquisition request message to the N relay source devices 201 to 20N.

The first receiving unit 402 receives the image information created by the relay source device from the N relay source devices 201 to 20N as a response to the image information acquisition request message. The first receiving unit 402 stores the received image information in a storage area in the first storage unit 421, instructed by the first determining unit 411.

When the received image information is compressed, the first receiving unit 402 performs a decompression process.

The first storage unit 421 stores the image information received from the relay source devices 201 to 20N. The first storage unit 421 corresponds to the frame buffer 124 of the first embodiment.

The first determining unit 411 determines a storage area in the first storage unit 421 in which the image information received from the N relay source devices 201 to 20N is stored.

The first determining unit 411 may be a setting file A that designates a storage area by the order in which the relay source device is “discovered” by the screen relay device 400. When the first determining unit 411 is the setting file A, the first receiving unit 402 stores the received image information in the first storage unit 421 by referring to the setting file A.

The second storage unit 422 stores the image information transmitted to the relay destination device 301. The second storage unit 422 corresponds to the backup image storage unit 123 of the first embodiment.

The correlating unit 412 stores a correspondence between the image information stored in the first storage unit 421 and the image information stored in the second storage unit 422. The correlating unit 412 may be a setting file B that describes correspondence information.

The detecting unit 413 acquires the correspondence information from the correlating unit 412 and compares the pixel values of the image information items stored in the first storage unit 421 and the second storage unit 422 to thereby detect a region where a difference is present. When the correlating unit 412 is the setting file B, the detecting unit 413 can identify the areas of the image information items of which the pixel values are compared between the first storage unit 421 and the second storage unit 422 by referring to the setting file B.

The updating unit 414 stores the image information in the first storage unit 421 corresponding to the difference region detected by the detecting unit 413 in the second storage unit 422 as updated image information. Moreover, the updating unit 414 notifies the second transmitting unit 403 of information representing the difference region.

The second transmitting unit 403 acquires the image information of the difference region from the second storage unit 422 using the information representing the difference region notified from the updating unit 414 and transmits the image information to the relay destination device 301. The image information may be compressed when transmitting the same.

The first transmitting unit 401, the first receiving unit 402, and the second transmitting unit 403 correspond to the communication unit 122 of the first embodiment. Moreover, the second transmitting unit 403 has the function of the compression process by the screen transfer unit 136 of the first embodiment. Moreover, the first receiving unit 402 and the first determining unit 411 correspond to the determining unit 131 and the rendering unit 132 of the first embodiment.

As above, the screen relay device 400 of the present embodiment can receive the image information from N relay source devices, arbitrarily combine or divide the images to create one image information item, and transfer the created image information to one relay destination device.

Moreover, the calculation of the number of threads as described in the first embodiment may be performed by the processes of the detecting unit 413, the updating unit 414, and the second transmitting unit 403, and parallel processing may be performed with the calculated number of threads. In this way, it is possible to transmit the image information to the relay destination device efficiently.

### Third Embodiment

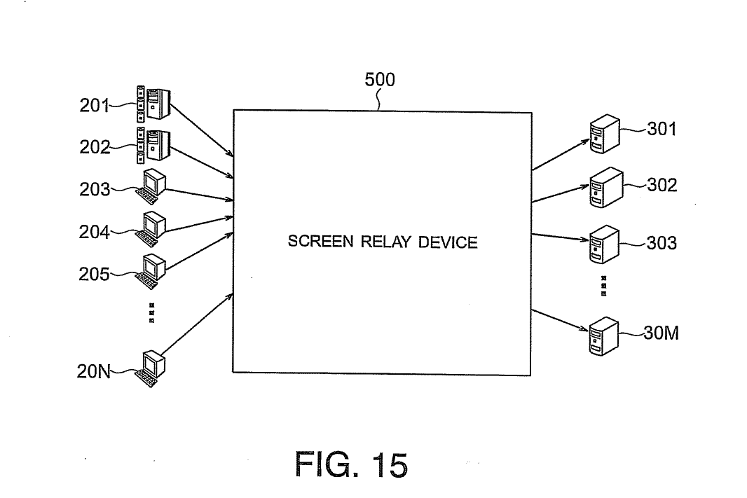

FIG. 15 illustrates a schematic configuration of a screen relay system according to a third embodiment of the invention. The screen relay system includes a screen relay device 500, N relay source devices 201 to 20N, and M relay destination devices 301 to 30M. Here, N and M are integers of 1 or more.

The screen relay device 500 arbitrarily combines or divides the images created by the relay source devices 201 to 20N and transmits the combined image or the divided images to the relay destination devices 301 to 30M. Moreover, when images displayed by the relay destination devices 301 to 30M are updated (when a change occurs), the screen relay device 100 transmits an updated image to the relay destination devices 301 to 30M.

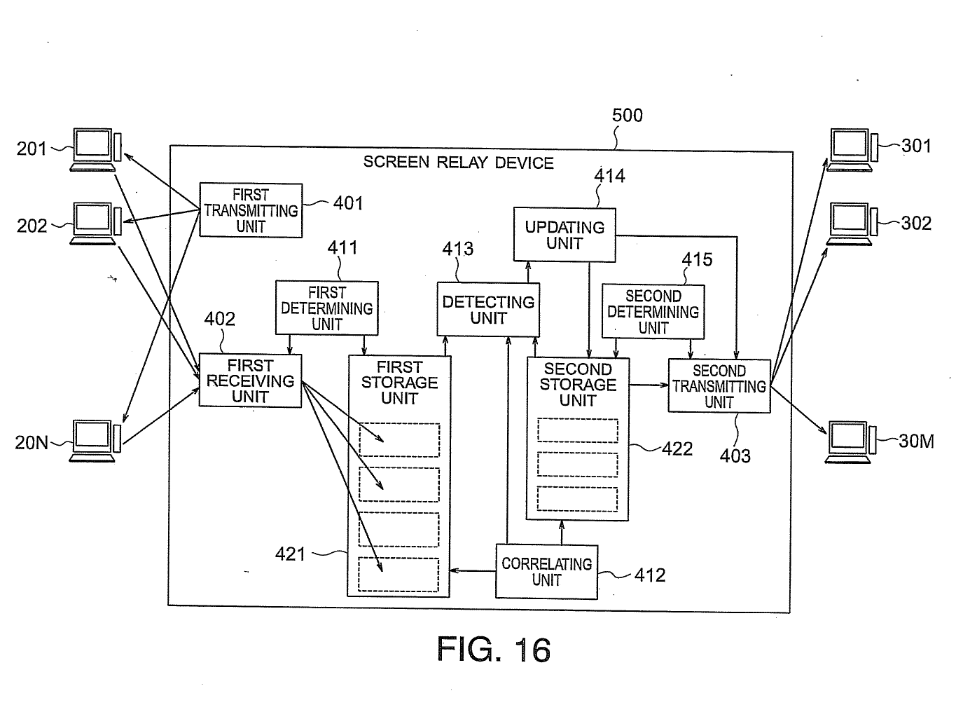

FIG. 16 illustrates a schematic configuration of the screen relay device 500. The screen relay device 500 has a configuration in which a second determining unit 415 is included in the screen relay device 400 according to the second embodiment illustrated in FIG. 13.

The screen relay device 500 is one in which the functions of the screen relay device 400 are expanded. The second transmitting unit 403 can transmit the image information to M relay destination devices 301 to 30M. The image information items transmitted to the respective relay destination devices are stored in the second storage unit 422 in a divided manner.

The second determining unit 415 determines a storage area of the second storage unit 422 in which the image information items transmitted or having been transmitted to the M relay destination devices 301 to 30M are stored.

The second determining unit 415 may be a setting file C that designates a storage area in the second storage unit 422 by the order in which the relay destination device is “discovered” by the screen relay device 500. When the second determining unit 415 is the setting file C, the second transmitting unit 403 specifies a storage area of the second storage unit 422 corresponding to a relay destination device of a transmission destination by referring to the setting file C when transmitting the image information to the relay destination device and transmits the image information stored in the storage area.

The correlating unit 412, the detecting unit 413, and the updating unit 414 illustrated in FIG. 16 are those in which the respective functions described in the second embodiment are expanded so as to correspond to the M relay destination devices 301 to 30M.

As above, the screen relay device 500 of the present embodiment can receive the image information items from the N relay source devices, arbitrarily combine or divide the images to create M image information items, and transfer the created image information to the M relay destination devices.

Moreover, the calculation of the number of threads as described in the first embodiment may be performed by the processes of the detecting unit 413, the updating unit 414, and the second transmitting unit 403, and parallel processing may be performed with the calculated number of threads. In this way, it is possible to transmit the image information to the relay destination device efficiently.

At least part of the screen relay device described in the above embodiments may be implemented in either hardware or software. When implemented in software, a program that realizes at least part of functions of the screen relay device may be stored on a (non-volatile) recording medium such as a flexible disk or CD-ROM and read and executed by a computer. The recording medium is not limited to a removable recording medium such as a magnetic disk or optical disk, but. may be a non-removable recording medium such as a hard disk device or memory.

The program that realizes at least part of the functions of the screen relay device may be distributed through a communication line (including wireless communications) such as the Internet. Further, the program may be encrypted, modulated, or compressed to be distributed through a wired line or wireless line such as the Internet or to be distributed by storing the program on a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A screen relay device comprising:
a communication unit that transmits an image information acquisition request to a plurality of relay source devices, receives first image information corresponding to the image information acquisition request from the relay source devices, and transmits second image information to a relay destination device;
a first storage unit that stores the first image information;
a second storage unit that stores the second image information;
a determining unit that determines a storage area of the first image information in the first storage unit;
a rendering unit that renders the first image information in the determined storage area;
a third storage unit that stores an updated region where the image information stored in the first storage unit has been updated by the rendering of the rendering unit; and
a screen transfer unit that reads the first image information corresponding to the updated region from the first storage unit, reads the second image information corresponding to the updated region from the second storage unit, compares the read first image information and the read second image information to extract a difference region, writes the first image information of the difference region to the second storage unit as the second image information, and outputs the second image information to the communication unit.

2. The device according to claim 1, further comprising a calculating unit that calculates a first parallel count based on the number of the updated regions,
wherein the screen transfer unit executes a process of extracting the difference region in parallel with the first parallel count.

3. The device according to claim 2,
wherein the calculating unit calculates the first parallel count based on the number of the updated regions and the area of the updated region.

4. The device according to claim 3, further comprising a fourth storage unit that stores boundary information representing boundaries of a region displayed by the relay destination device within the first image information stored in the first storage unit,
wherein the calculating unit calculates a second parallel count based on the boundary information, and
wherein the screen transfer unit executes a compression process of compressing the second image information in parallel using the second parallel count and outputs the compressed second image information to the communication unit.

5. The device according to claim 4,
wherein the calculating unit calculates the first parallel count and/or the second parallel count based on the boundary information, the number of the updated regions, and the area of the updated region.

6. A screen relay system comprising:
a plurality of relay source devices which receive an image information acquisition request and transmit first image information;
a relay destination device which receives second image information; and
a screen relay device including:
a communication unit that transmits the image information acquisition request to the plurality of relay source devices, receives the first image information corresponding to the image information acquisition request from the relay source devices, and transmits the second image information to the relay destination device;
a first storage unit that stores the first image information;
a second storage unit that stores the second image information;
a determining unit that determines a storage area of the first image information in the first storage unit;
a rendering unit that renders the first image information in the determined storage area;
a third storage unit that stores an updated region where the image information stored in the first storage unit has been updated by the rendering of the rendering unit; and
a screen transfer unit that reads the first image information corresponding to the updated region from the first storage unit, reads the second image information corresponding to the updated region from the second storage unit, compares the read first image information and the read second image information to extract a difference region, writes the first image information of the difference region to the second storage unit as the second image information, and outputs the second image information to the communication unit.

7. The system according to claim 6,
wherein the screen relay device further includes a calculating unit that calculates a first parallel count based on the number of the updated regions, and
wherein the screen transfer unit executes a process of extracting the difference region in parallel with the first parallel count.

8. The system according to claim 7,
wherein the calculating unit calculates the first parallel count based on the number of the updated regions and the area of the updated region.

9. The system according to claim 8,
wherein the screen relay device further includes a fourth storage unit that stores boundary information representing boundaries of a region displayed by the relay destination device within the first image information stored in the first storage unit,
wherein the calculating unit calculates a second parallel count based on the boundary information, and
wherein the screen transfer unit executes a compression process of compressing the second image information in parallel using the second parallel count and outputs the compressed second image information to the communication unit.

10. The system according to claim 9,
wherein the calculating unit calculates the first parallel count and/or the second parallel count based on the boundary information, the number of the updated regions, and the area of the updated region.

11. A computer-readable storage medium storing a screen relay program which causes a computer to execute the steps of:
transmitting an image information acquisition request to a plurality of relay source devices;
receiving first image information corresponding to the image information acquisition request from the relay source devices;
determining a storage area of the first image information in a first storage unit;
rendering the first image information in the determined storage area;
reading the first image information corresponding to an updated region where the image information stored in the first storage unit has been updated by the rendering;
reading second image information corresponding to the updated region from a second storage unit, the second storage unit storing the second image information transmitted to a relay destination device;
comparing the read first image information and the read second image information to extract a difference region;
writing the first image information of the difference region to the second storage unit as the second image information; and
transmitting the second image information to the relay destination device.

12. The computer-readable storage medium according to claim 11,
wherein the screen relay program causes the computer to execute the step of:
calculating a first parallel count based on the number of the updated regions; and
executing a process of extracting the difference region in parallel with the first parallel count.

13. The computer-readable storage medium according to claim 12,
wherein the first parallel count is calculated based on the number of the updated regions and the area of the updated region.

14. The computer-readable storage medium according to claim 13,
wherein the screen relay program causes the computer to execute the step of:
calculating a second parallel count based on boundary information representing boundaries of a region displayed by the relay destination device within the first image information stored in the first storage unit;
executing a compression process of compressing the second image information in parallel using the second parallel count; and
transmitting the compressed second image information to the relay destination device.

15. The computer-readable storage medium according to claim 14,
wherein the first parallel count and/or the second parallel count is calculated based on the boundary information, the number of the updated regions, and the area of the updated region.
